(19) United States
(12) Patent Application Publication
(10) Pub. No.: US 2023/0067133 A1
(43) Pub. Date: Mar. 2, 2023

(54) IN-VEHICLE SHUTDOWN DEVICE

(71) Applicant: TOYOTA JIDOSHA KABUSHIKI KAISHA, Toyota-shi Aichi-ken (JP)

(72) Inventor: Yuki Shimizu, Toyota-shi Aichi-ken (JP)

(73) Assignee: TOYOTA JIDOSHA KABUSHIKI KAISHA, Toyota-shi Aichi-ken (JP)

(21) Appl. No.: 17/876,011

(22) Filed: Jul. 28, 2022

(30) Foreign Application Priority Data
Sep. 1, 2021 (JP) 2021-142084

(51) Int. Cl. B60L 3/04; B60L 3/00; H01H 39/00

(52) U.S. Cl. CPC B60L 3/04; B60L 3/0046; H01H 39/006

(57) ABSTRACT

In an in-vehicle shutdown device, only a pyro-fuse is provided on one line of a positive-side line and a negative-side line as a device that shuts off the one line, and a breaker of a different type from the pyro-fuse, which is operable to be switched by a control signal to shut off and stop shut-off of the other line, is provided on the other line. A controller controls the pyro-fuse to cut the one line in the event of an abnormality that the breaker is stuck closed.

### CROSS-REFERENCE TO RELATED APPLICATION

This application claims priority to Japanese Patent Application No. 2021-142084 filed on Sep. 1, 2021, incorporated herein by reference in its entirety.

### BACKGROUND

### 1. Technical Field

The disclosure relates to an in-vehicle shutdown device, and more particularly to an in-vehicle shutdown device that is installed in a vehicle along with a battery and a load that operates with electric power from the battery, and is provided on a power line between the battery and the load such that it can shut off the power line.

### 2. Description of Related Art

One example of the above type of in-vehicle shutdown device, which includes a pyro-fuse (explosive-type cutoff switch) and is installed in a vehicle along with a battery (in-vehicle power supply) and a load, has been proposed (see, for example, Japanese Unexamined Patent Application Publication No. 2017-41987 (JP 2017-41987 A)). The pyro-fuse is provided on a power line, and cuts the power line using the explosive force of an explosive. The load operates with electric power from the battery. This device includes a diode. The diode has an anode connected to the reference potential, and a cathode connected to a drive unit of the pyro-fuse. In this device, when the battery is reverse-connected and a voltage lower than the reference potential is applied to the power line, current flows into the drive unit of the pyro-fuse via the diode, to ignite the explosive of the pyro-fuse and cut the power line. In this manner, excessive current is prevented from flowing in the power line. Another example of the in-vehicle shutdown device, which includes pyro-fuses (switches) and two breakers (main switches) and is installed in a vehicle along with a battery (battery block) and a load (inverter), has been proposed (see, for example, Japanese Unexamined Patent Application Publication No. 7-59202 (JP 7-59202 A)). The pyro-fuses (switches) are provided on a positive-side line of power lines. The load operates with electric power from the battery. The two breakers connect and disconnect the positive-side line and negative-side line of the power lines. In this device, the pyro-fuse cuts the positive-side line by igniting the explosive upon an impact due to a collision. Thus, voltage is prevented from being applied to the power lines in the event of the collision, thus ensuring safety.

### SUMMARY

However, in the in-vehicle shutdown device of JP 2017-41987 A, the power line is shut off by the pyro-fuse, which makes it impossible to repeatedly shut off the power line and stop shut-off of the power line. Also, in the in-vehicle shutdown device of JP 7-59202 A, the two breakers and the pyro-fuses are used for shutting off the power lines, resulting in increase of the number of components. As a method of reducing the number of components, it may be considered to eliminate the breaker on the positive-side line on which the pyro-fuse is provided. In the case where the breaker on the positive-side line is eliminated, if a stuck-closed abnormality (an abnormality of the breaker that is stuck closed) occurs in the breaker on the negative-side line, the battery voltage may be applied to the power lines, and the battery voltage may be applied to the outside.

The disclosure provides an in-vehicle shutdown device that curbs application of a battery voltage to the outside when there is a stuck-closed abnormality of a breaker.

An in-vehicle shutdown device according to one aspect of the disclosure, which is installed in a vehicle along with a battery and a load that operates with electric power from the battery, includes a pyro-fuse provided on a first line as one of a positive-side line and a negative-side line of power lines between the battery and the load. The pyro-fuse is configured to cut the first line using explosive force of an explosive. The in-vehicle shutdown device also includes a breaker of a different type from the pyro-fuse, which is provided on a second line as the other of the positive-side line and the negative-side line and is operable to be switched by a control signal to shut off and stop shut-off of the second line, and a controller configured to control the pyro-fuse and the breaker. In this in-vehicle shutdown device, only the pyro-fuse is provided on the first line as a device that shuts off the first line, and the controller is configured to control the pyro-fuse to cut the first line in an event of an abnormality that the breaker is stuck closed.

In the in-vehicle shutdown device according to the above aspect of the disclosure, only the pyro-fuse is provided on the first line as a device for shutting off the first line. Then, the controller controls the pyro-fuse to cut the first line in the event of an abnormal condition where the breaker is stuck closed. With this arrangement, when the stuck-closed abnormality occurs in the breaker, the first line is cut, and the battery voltage is prevented from being supplied to the load side. As a result, when the stuck-closed abnormality occurs in the breaker, application of the battery voltage to the outside can be curbed.

In the in-vehicle shutdown device according to the above aspect of the disclosure, the controller may be configured to control the pyro-fuse to cut the first line in the event of the abnormality, when a predetermined time elapses from occurrence of the abnormality that the breaker is stuck closed. With this arrangement, application of the battery voltage to the outside can be curbed by cutting the first line after a lapse of the predetermined time from occurrence of the stuck-closed abnormality.

In the in-vehicle shutdown device of the above aspect, the controller may be configured to control the pyro-fuse to cut the first line in the event of the abnormality when receiving a repair start signal for starting repair. With this arrangement, application of the battery voltage to the outside can be curbed by cutting the first line when there is a stuck-closed abnormality and the repair start signal is received.

In the in-vehicle shutdown device of the above aspect, the breaker may be a relay. In the case where the breaker is the relay, too, application of the battery voltage to the outside can be curbed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view schematically showing the configuration of a battery electric vehicle equipped with an in-vehicle shutdown device as one embodiment of the disclosure;

FIG. 2 is a flowchart illustrating one example of a processing routine executed by a vehicle electronic control unit (ECU); and

FIG. 3 is an explanatory view showing one example of the relationship between the maximum value of current (allowable current) allowed to flow in a positive-side line and the maximum time for which the allowable current can flow continuously.

### DETAILED DESCRIPTION OF EMBODIMENTS

Next, the mode for carrying out the disclosure will be described using an embodiment.

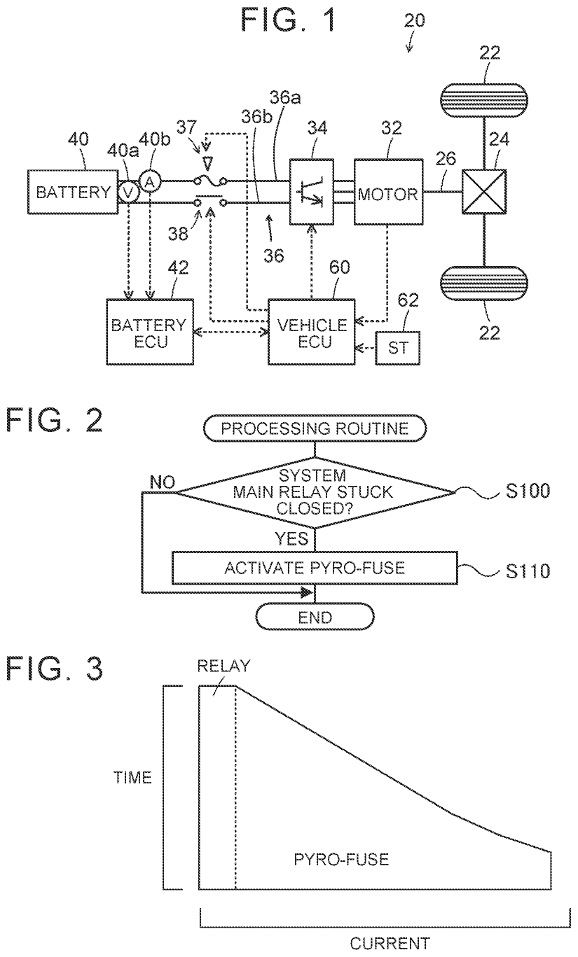

FIG. 1 schematically shows the configuration of a battery electric vehicle 20 equipped with an in-vehicle shutdown device as one embodiment of the disclosure. As shown in FIG. 1, the battery electric vehicle 20 of the embodiment includes a motor 32 for driving the vehicle, inverter 34, power lines 36 a pyro-fuse 37, a system main relay 38, a battery 40 as a power storage device, an electronic control unit for battery (which will be referred to as “battery ECU”) 42, and an electronic control unit for vehicle (which will be referred to as “vehicle ECU”) 60. The in-vehicle shutdown device of the embodiment consists principally of the pyro-fuse 37, system main relay 38, and vehicle ECU 60.

The motor 32 is configured as a synchronous generator-motor, for example, and the rotor of the motor 32 is connected to a drive shaft 26 connected to drive wheels 22 via a differential gear unit 24. The inverter 34 is connected to the motor 32 and also connected to the power lines 36. The motor 32 is driven when the vehicle ECU 60 performs switching control on a plurality of switching devices (not shown) of the inverter 34.

The pyro-fuse 37, which is provided on a positive-side line 36a of the power lines 36, is configured as a normally-on explosive-type cutoff switch that cuts the positive-side line 36a by driving a cutting blade toward the positive-side line 36a using the explosive force of an explosive. The pyro-fuse 37 is controlled by the vehicle ECU 60. Only the pyro-fuse 37 is connected to the positive-side line 36a of the power lines 36 as a device for interrupting electric current.

The system main relay 38 is configured as a mechanical relay using an electromagnet, and is provided on a negative-side line 36b of the power lines 36. The system main relay 38 is turned off to shut off the negative-side line 36b and is turned on to stop shut-off of the negative-side line 36b. The system main relay 38 is controlled by the vehicle ECU 60.

The battery 40 is configured as a lithium-ion secondary battery, for example, and is connected to the power lines 36. The battery ECU 42 includes a microprocessor having a central processing unit (CPU), read-only memory (ROM), random access memory (RAM), flash memory, input/output (I/O) ports, and communication ports, which are not shown in FIG. 1. The battery ECU 42 receives signals from various sensors via the input port. The signals input to the battery ECU 42 include, for example, voltage Vb of the battery 40 received from a voltage sensor 40a mounted between terminals of the battery 40, and current Ib of the battery 40 received from a current sensor 40b mounted to the output terminal of the battery 40. The battery ECU 42 computes the power storage ratio SOC of the battery 40 based on the integrated value of the current Ib (which assumes a positive value when being discharged from the battery 40) of the battery 40 from the current sensor 40b. The battery ECU 42 is connected to the vehicle ECU 60 via the communication port.

The vehicle ECU 60 includes a microprocessor having CPU, ROM, RAM, flash memory, I/O ports, and communication ports, which are not shown in FIG. 1. The vehicle ECU 60 receives signals from various sensors via the input port. The signals input to the vehicle ECU 60 include, for example, the rotational position θm of the rotor of the motor 32 from a rotational position sensor (e.g., a resolver) that detects the rotational position of the rotor of the motor 32, and a start signal from a start switch 62. The vehicle ECU 60 also functions as a drive control unit of the vehicle; therefore, the signals input to the vehicle ECU 60 also include, for example, the shift position received from a shift position sensor that detects the operation position of the shift lever, an accelerator pedal position or stroke received from an accelerator pedal position sensor that detects the amount of depression of the accelerator pedal, and the vehicle speed received from a vehicle speed sensor. Various control signals are generated from the vehicle ECU 60 via the output port. The signals output from the vehicle ECU 60 include, for example, control signals to the switching devices of the inverter 34, a control signal to the pyro-fuse 37, and a control signal to the system main relay 38. The vehicle ECU 60 is connected to the battery ECU 42 via the communication port.

In the battery electric vehicle 20 of the embodiment configured as described above, the system main relay 38 is in the OFF position and the negative-side line 36b is in the shut-off state during system off (when the start switch 62 is OFF). Thus, the battery 40 and the inverter 34 are disconnected from each other on the negative side. During system on (when the start switch 62 is ON), the system main relay 38 is in the ON position, and the shut-off state of the negative-side line 36b is stopped. Thus, the battery 40 and the inverter 34 are connected to each other on the negative side. During normal operation (before the explosive is ignited), the pyro-fuse 37 is in the ON position, and the positive-side line 36a is not shut off (i.e., the positive-side line 36a connects the positive electrode of the battery 40 and the positive electrode of the inverter 34). Thus, the battery 40 and the inverter 34 are connected to and disconnected from each other by turning on and off the system main relay 38.

Next, operation of the battery electric vehicle 20 of the embodiment, in particular, operation when a stuck-closed abnormality (an abnormality of the system main relay 38 that is closed and will not open) occurs in the system main relay 38 during system on. FIG. 2 is a flowchart illustrating one example of a processing routine executed by the vehicle ECU 60. The routine is executed before the start switch 62 is switched from OFF to ON, and the system main relay 38 is turned on. Namely, before execution of this routine, the pyro-fuse 37 is ON, and the system main relay 38 is OFF.

When this routine is executed, the vehicle ECU 60 determines whether there is a stuck-closed abnormality in the system main relay 38 (step S100). In this step, the vehicle ECU 60 receives the voltage Vb of the battery 40 from the voltage sensor 40a via the battery ECU 42, and checks if the input voltage Vb exceeds a reference voltage Vref (e.g., 5V, 10V, 15V, etc.). When the voltage Vb of the battery 40 exceeds the reference voltage Vref, the vehicle ECU 60 determines that there is a stuck-closed abnormality.

When the vehicle ECU 60 determines in step S100 that there is no stuck-closed abnormality in the system main relay 38, it finishes the routine. When there is a stuck-closed abnormality, the vehicle ECU 60 sends a control signal to the pyro-fuse 37 so as to activate the pyro-fuse 37 (step S110), and finishes the routine. Through this process, the explosive of the pyro-fuse 37 explodes, and the cutting blade is driven using the explosive force of the explosive, to cut the positive-side line 36a. In this manner, the voltage of the battery 40 is prevented from being supplied to the inverter 34 side, and application of the voltage of the battery 40 to the outside is curbed.

FIG. 3 shows one example of the relationship between the maximum value of the current (allowable current) allowed to flow in the positive-side line 36a and the maximum time for which the allowable current can flow continuously. FIG. 3 shows, as a comparative example, one example of the relationship between the maximum value of the allowable current in the positive-side line 36a when a mechanical relay with contacts is used in the positive-side line 36a in place of the pyro-fuse 37, and the maximum time for which the allowable current can flow continuously, by use of a broken line. As shown in FIG. 3, the use of the pyro-fuse 37 in the positive-side line 36a allows the larger current to flow in the positive-side line 36a for the longer period of time. This is based on the fact that, when a relatively large current flows in a mechanical relay with contacts, the contacts may stick to each other, or an arc may be generated to wear out the contacts. The pyro-fuse 37 thus provided on the positive-side line 36a can be properly activated even when a certain large current flows so that the pyro-fuse 37 can cut the positive-side line 36a.

In the in-vehicle shutdown device installed in the battery electric vehicle 20 of the illustrated embodiment, the system main relay 38 of a different type from the pyro-fuse 37 is provided on the negative-side line 36b for shutting off and stopping shut-off of the negative-side line 36b, and only the pyro-fuse 37 is provided on the positive-side line 36a as the device for shutting off the positive-side line 36a. In the event of an abnormality where the system main relay 38 is stuck closed, the pyro-fuse 37 is controlled to cut the positive-side line 36a, so that application of the voltage of the battery 40 to the outside can be curbed when the stuck-closed abnormality occurs in the system main relay 38.

In the in-vehicle shutdown device installed in the battery electric vehicle 20 of the embodiment, the pyro-fuse 37 is activated when the stuck-closed abnormality occurs in the system main relay 38. However, the pyro-fuse 37 may be activated when a predetermined time (e.g., 10 min., 20 min., 30 min., etc.) elapses from the time when the system main relay 38 gets stuck closed. Since it may be considered to take some measure, such as limp-home traveling, after the system main relay 38 is stuck closed, activation of the pyro-fuse 37 can be curbed before this measure is taken or while the measure is being taken. Also, the pyro-fuse 37 may be activated when a repair start signal for starting repair is received. Thus, activation of the pyro-fuse 37 can be curbed before the vehicle enters a repair shop and the repair start signal for starting repair is received.

In the in-vehicle shutdown device installed in the battery electric vehicle 20 of the embodiment, the pyro-fuse 37 is provided on the positive-side line 36a, and the system main relay 38 is provided on the negative-side line 36b. However, the pyro-fuse 37 may be provided on the negative-side line 36b, and the system main relay 38 may be provided on the positive-side line 36a.

In the in-vehicle shutdown device installed in the battery electric vehicle 20 of the embodiment, the system main relay 38 in the form of a mechanical relay using an electromagnet is provided on the negative-side line 36b. However, the system main relay 38 may be in the form of a breaker, such as a contactless relay using semiconductor devices, which can be switched by a control signal to shut off and stop shut-off of the negative-side line 36b.

In the in-vehicle shutdown device installed in the battery electric vehicle 20 of the embodiment, the system main relay 38 is provided on the negative-side line 36b. However, a capacitor may be provided such that its opposite ends are connected to the positive-side line 36a and the negative-side line 36b at positions of the power lines 36 between the pyro-fuse 37 and the inverter 34 and between the system main relay 38 and the inverter 34, and a relay for charging and a resistor for charging, which are connected in series with each other, may be provided on the negative-side line 36b in parallel with the system main relay 38. In this case, when the system is switched from OFF to ON, the relay for charging is initially turned on to charge the capacitor, and then the system main relay 38 is turned on. During execution of the processing routine of FIG. 2, the relay for charging may be kept OFF.

While the disclosure is applied to the in-vehicle shutdown device installed in the battery electric vehicle including the battery 40 and the inverter 34 in this embodiment, the in-vehicle shutdown device of the disclosure may be installed in a vehicle of any configuration provided that the vehicle includes a battery and a load that operates with electric power from the battery.

The relationship between the main elements of the embodiment and the main elements of the disclosure described in the “SUMMARY” section above will be described. In the embodiment, the pyro-fuse 37 corresponds to the “pyro-fuse”, the system main relay 38 corresponds to the “breaker”, and the vehicle ECU 60 functions as the “controller”. Also, one of the positive-side line 36a and the negative-side line 36b on which the pyro-fuse 37 is provided functions as the “first line”, and the other line on which the system main relay 38 is provided functions as the “second line”.

The relationship between the main elements of the embodiment and the main elements of the disclosure described in the “SUMMARY” section above is one example for specifically describing the mode for carrying out the disclosure described in the “SUMMARY”, and is thus not intended to limit the elements of the disclosure described in the “SUMMARY” section. Namely, the disclosure described in the “SUMMARY” section should be construed based on the description in that section, and the embodiment is a mere specific example of the disclosure described in the “SUMMARY” section.

While the mode for carrying out the disclosure has been described using the embodiment, the disclosure is by no means limited to the embodiment, but may be naturally carried out in various forms, without departing from the principle of the disclosure.

The disclosure can be used in the manufacturing industry for in-vehicle shutdown devices and other applications.

What is claimed is:

1. An in-vehicle shutdown device installed in a vehicle along with a battery and a load that operates with electric power from the battery, the in-vehicle shutdown device comprising:
a pyro-fuse provided on a first line as one of a positive-side line and a negative-side line of power lines between the battery and the load, the pyro-fuse being configured to cut the first line using explosive force of an explosive;
a breaker of a different type from the pyro-fuse, which is provided on a second line as the other of the positive-side line and the negative-side line and is operable to be switched by a control signal to shut off and stop shut-off of the second line; and
a controller configured to control the pyro-fuse and the breaker,
wherein only the pyro-fuse is provided on the first line as a device that shuts off the first line, and
wherein the controller is configured to control the pyro-fuse to cut the first line in an event of an abnormality that the breaker is stuck closed.

2. The in-vehicle shutdown device according to claim 1, wherein the controller is configured to control the pyro-fuse to cut the first line in the event of the abnormality, when a predetermined time elapses from occurrence of the abnormality that the breaker is stuck closed.

3. The in-vehicle shutdown device according to claim 1, wherein the controller is configured to control the pyro-fuse to cut the first line in the event of the abnormality when receiving a repair start signal for starting repair.

4. The in-vehicle shutdown device according to claim 1, wherein the breaker comprises a relay.

5. The in-vehicle shutdown device according to claim 1, further comprising:
a capacitor with opposite ends connected to the first line and the second line at positions between the pyro-fuse and the load and between the breaker and the load; and
a relay for charging and a resistor for charging which are provided on the second line in parallel with the breaker and are connected in series with each other.
